(19) United States
(12) Patent Application Publication
(10) Pub. No.: US 2024/0067337 A1
(43) Pub. Date: Feb. 29, 2024

(54) SUSPENSION AND CONTROL HEAD APPARATUS FOR AERIAL FIREFIGHTING BUCKET

(71) Applicant: Donmark Holdings Inc., Delta (CA)

(72) Inventors: Donald ARNEY, Delta (CA); Paul MILBERS, Delta (CA)

(21) Appl. No.: 18/118,144

(22) Filed: Mar. 7, 2023

Related U.S. Application Data
(60) Provisional application No. 63/317,406, filed on Mar. 7, 2022.

(51) Int. Cl. B64D 1/16

(52) U.S. Cl. CPC B64D 1/16; A62C 3/0235

(57) ABSTRACT

A suspension and control head apparatus for an aerial firefighting bucket comprising: a rigid frame member having an upper cargo attachment portion that is removably connectable to a cargo hook of a hover capable aircraft, the frame member including lower spaced apart cable attachment portions that are removably connectable to support cables that support the bucket; the frame member defining bilateral opposite sides, one side being a solenoid side and the opposite side being a reel side; a solenoid mounted on the solenoid side, the solenoid being coupled to an electrical source and a switch that energizes and deenergizes the solenoid; a spring-loaded reel rotatably mounted on the reel side, the reel having wound thereon a cable when the reel is in a relaxed or nearly relaxed state, the cable having a stop member, wherein the solenoid and the reel are adjacent to each other on the opposite sides; a latch that interferes with the stop member when the latch is in a latched position and the latch being moveable to a released position in which the latch releases the stop member; a linkage that communicates from the solenoid side to the reel side, the linkage on the solenoid side being connected to the solenoid, the linkage on the reel side being connected to the latch, and the solenoid being operable to release the latch to be moved to the released position when the solenoid is energized; and wherein with the stop member being released, the cable may be unwound from the reel against the spring bias of the reel with application of a downward force on the cable.

### FIELD OF THE INVENTION

The invention relates to aerial firefighting buckets and to improved suspension and control head apparatus for aerial firefighting buckets.

### BACKGROUND OF THE INVENTION

Aerial firefighting buckets, particularly those for carrying by helicopter or other hover capable aircraft, are well known. Some examples of aerial firefighting buckets in the prior art are disclosed in U.S. Pat. Nos. 4,474,245; 4,576,237; 5,560,429; 7,708,082; and 8,453,753. These patents disclose helicopter carried firefighting buckets that, at their simplest, comprise a rigid or flexible reservoir for holding a volume of water, a sling to suspend the reservoir from a helicopter, a valve, and an actuator which is controlled from inside the helicopter to operate the valve to release the water from the reservoir over the fire. In FIG. 1 there is shown an example of a prior art aerial firefighting bucket system shown generally as 10. The system 10 includes a bucket 12 for containing a volume of fluid. The bucket 12 includes a bottom interior surface having a valve 18 thereon for controllably releasing a stream 24 of the fluid over a fire, for example. The bucket 12 is suspended from a control head 26 by support cables 15 and the control head 26 is connected to the cargo hook 20 of helicopter 22. A control cable 16 runs between the helicopter 22 and the control head 26 to transmit instructions from an operator to the control head 26. The control cable 16 may be an electrical cable, a hydraulic hose, or a pneumatic hose, for example. An actuator cable 28 may be connected between the control head 26 and the valve 18 to enable the control head 26 to open and close the valve 18 in response to operator commands. Various actuator mechanisms of the control head 26 are known in the prior art, including some described in the patents mentioned above herein.

A problem with some control heads such as control head 26 of the prior art is that they may be too tall, particularly on helicopters with low skid gear. When landing, there is a danger of the helicopter landing on top of a control head that settles on the ground in an upright vertical orientation, which could cause an upward force into the cargo hook potentially damaging the cargo hook and the belly of the helicopter. Another problem with some control heads of the prior art is that the suspension lines often twist during filling and do not untwist once the bucket is in the air again. This could result in fowling of the trip line or actuator cable to the valve. The cause is attributable to the bucket support cable attachment points on each side of the control head not being far enough apart.

### SUMMARY OF THE INVENTION

The present invention addresses the difficulties and disadvantages of the prior art by providing a compact suspension and control head apparatus for an aerial firefighting bucket that is suspendable from an aircraft and operable to release fluid by a movable valve.

In one aspect, the present invention provides a suspension and control head apparatus for an aerial firefighting bucket comprising: a rigid frame member having an upper cargo attachment portion that is removably connectable to a cargo hook of a hover capable aircraft, the frame member including lower spaced apart cable attachment portions that are removably connectable to support cables that support the bucket; the frame member defining bilateral opposite sides, one side being a solenoid side and the opposite side being a reel side; a solenoid mounted on the solenoid side, the solenoid being coupled to an electrical source and a switch that energizes and deenergizes the solenoid; a spring-loaded reel rotatably mounted on the reel side, the reel having wound thereon a cable when the reel is in a relaxed or nearly relaxed state, the cable having a stop member, wherein the solenoid and the reel are adjacent to each other on the opposite sides; a latch that interferes with the stop member when the latch is in a latched position and the latch being moveable to a released position in which the latch releases the stop member; a linkage that communicates from the solenoid side to the reel side, the linkage on the solenoid side being connected to the solenoid, the linkage on the reel side being connected to the latch, and the solenoid being operable to release the latch to be moved to the released position when the solenoid is energized; and wherein with the stop member being released, the cable may be unwound from the reel against the spring bias of the reel with application of a downward force on the cable.

In some embodiments, the cable is connected to a dump valve of the bucket, and the downward force is provided by the weight of water in the bucket acting upon the dump valve.

In some embodiments, the reel is operable to rewind the cable once the downward force is diminished to a lesser magnitude than the force provided by the reel.

In some embodiments, the linkage comprises: a lobe on the solenoid side; a shaft connected to the lobe and extending to the reel side and the latch being connected to the shaft; and the solenoid is operable to release the lobe, which releases the latch to enable the latch to rotate from the latched position to the released position.

In some embodiments, the linkage further comprises a lever connected to a plunger of the solenoid, the lever having a roller that engages the lobe when the solenoid is deenergized, and wherein energizing the solenoid pulls the lever and the roller to release the lobe and thereby the latch.

In some embodiments, the suspension and control head apparatus further comprises a guide on the reel side that captures the stop member when the cable is wound onto the reel.

In some embodiments, the frame member is planar such that the cargo attachment portion and the cable attachment portions are in a plane.

A detailed disclosure following, related to drawings, describes a preferred embodiment of the invention which however is capable of expression in structure other than that particularly described and illustrated.

### DESCRIPTION OF THE DRAWINGS

In drawings which illustrate by way of example only embodiments of the invention:

FIG. 1 is a front elevation of an aerial fire-fighting bucket system of the prior art;

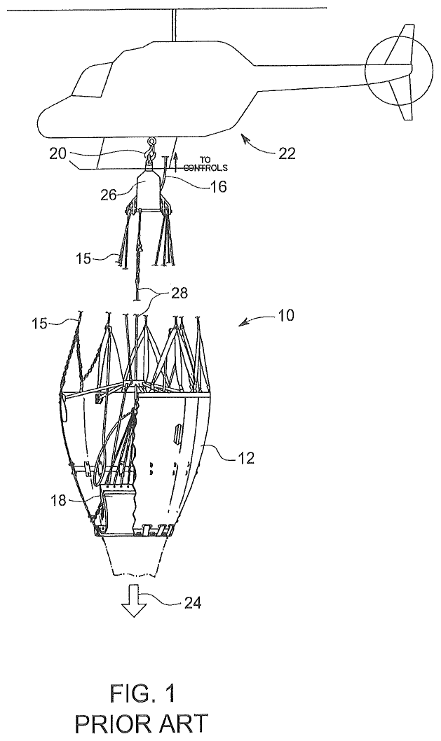

FIG. 2 is a front elevation of an aerial fire-fighting bucket system having a suspension and control head according to one aspect of the invention;

FIG. 3 is a front view of an embodiment of a suspension and control head apparatus of the present invention,

FIG. 4 is a perspective view of the suspension and control head apparatus of FIG. 3 with the enclosure covers removed to show the internal mechanical structures;

FIG. 5 is a side view of the suspension and control head apparatus of FIG. 4 in which the line on the reel is in a wound state;

FIG. 6 is an enlarged view of the latch mechanism below the reel of the apparatus in FIG. 5;

FIG. 7 is a side view of the solenoid side of suspension and control head apparatus of FIG. 4 in which the line on the reel is in a wound state;

FIG. 8 is an enlarged view of the solenoid mechanism and linkage of the apparatus in FIG. 7;

FIG. 9 is a side view of the suspension and control head apparatus of FIG. 4 showing the reel side in which the line on the reel is in an unwound state;

FIG. 10 is an enlarged view of the latch mechanism below the reel of the apparatus in FIG. 9;

FIG. 11 is a side view of the solenoid side of suspension and control head apparatus of FIG. 4 in which the line on the reel is in an unwound state; and

FIG. 12 is an enlarged view of the solenoid mechanism and linkage of the apparatus in FIG. 11.

### DETAILED DESCRIPTION

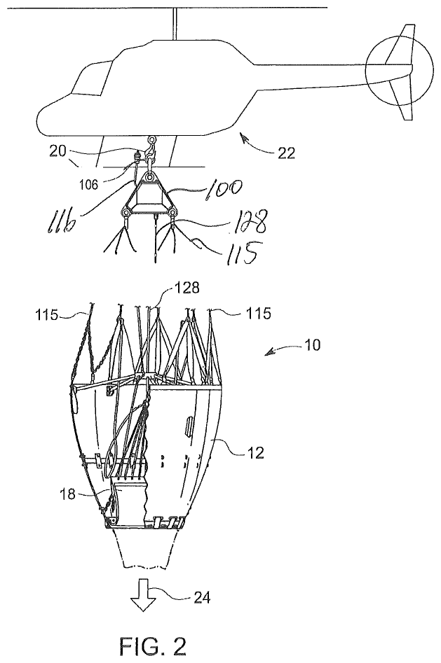

Referring to FIG. 2, there is shown an aerial fire-fighting bucket system having a suspension and control head apparatus 100, or simply referred to herein as a control head, according to one aspect of the invention. The aerial firefighting bucket system includes a bucket 12 for containing a volume of fluid. The bucket 12 includes a bottom interior surface having a valve 18 thereon for controllably releasing a stream 24 of the fluid over a fire, for example. The bucket 12 is suspended from the control head 100 by bucket support cables 115 and the control head 100 is suspended from cargo hook 20 of helicopter 22 by cargo ring or shackle 106. A valve control line such as control cable 128 is connected between an actuator mechanism in the control head 100 and the valve 18 to enable the control head 100 to open and close the valve 18 in response to operator commands. A communication cable 116 runs between the helicopter 22 and the control head 100 to transmit instructions from an operator to the control head 100. The communication cable 116 is an electrical cable in the illustrated embodiment but it could be a hydraulic hose or a pneumatic hose, for example, depending on the manner operation of the actuator mechanism. For example, communication cable 116 carries helicopter power to a solenoid in the actuator mechanism to actuate the control cable 128. Power comes from a control switch generally mounted on the cyclic control in the helicopter which is pressed to open the valve and dump the bucket.

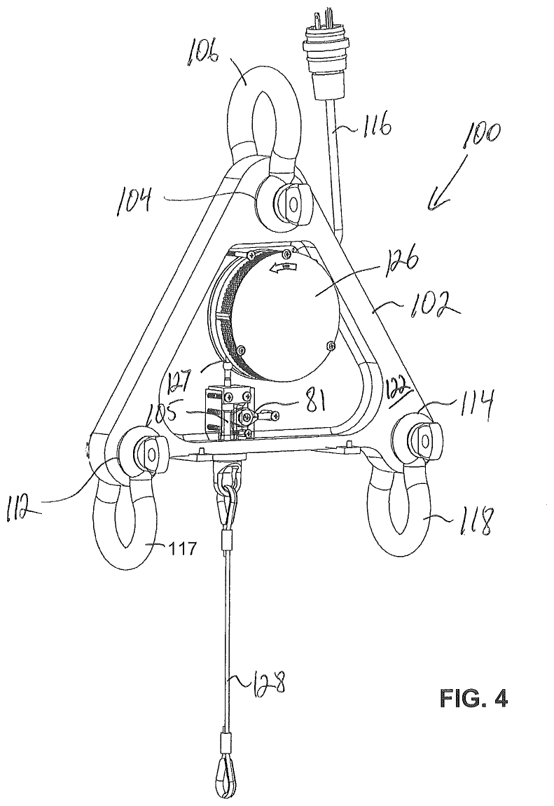

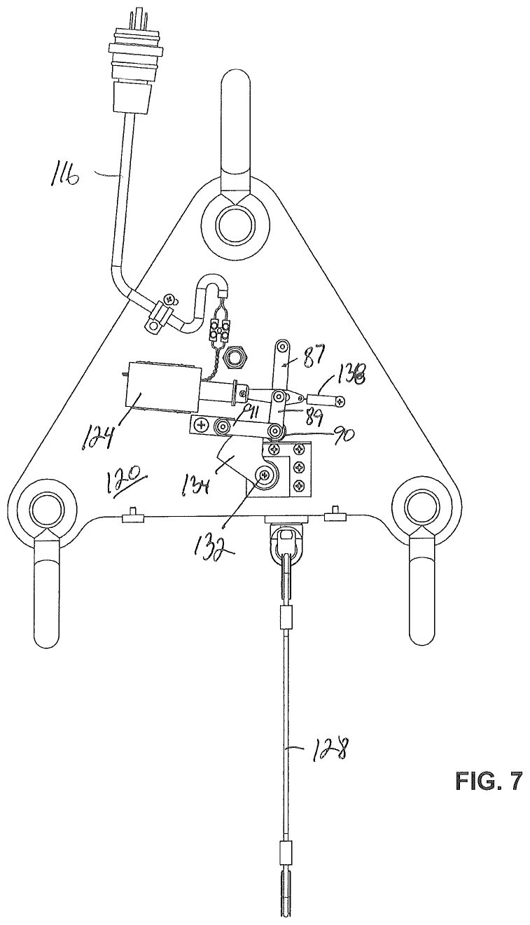

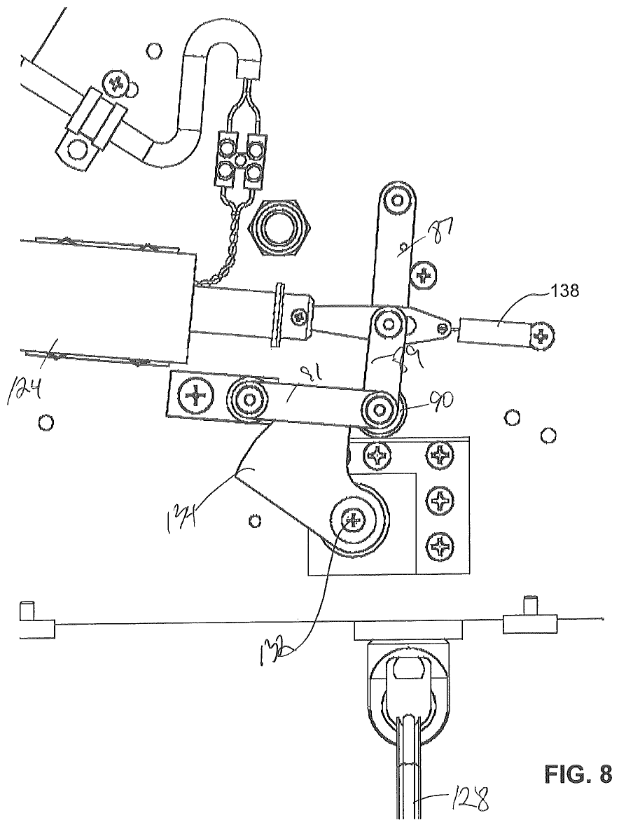

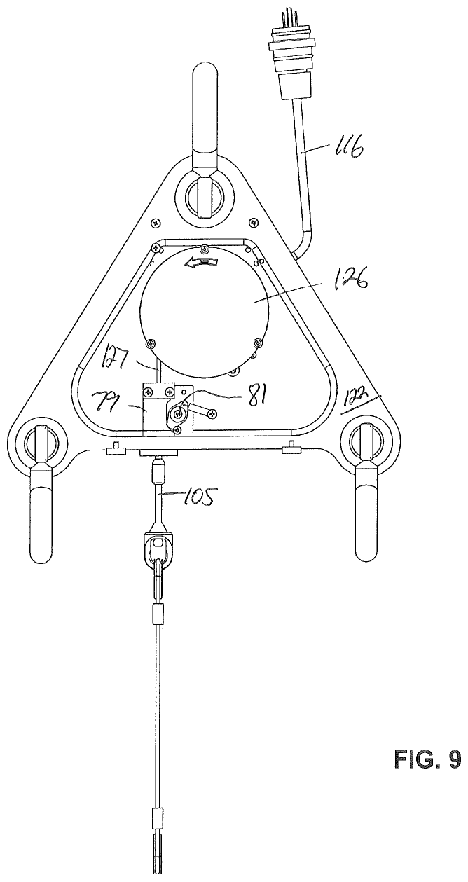

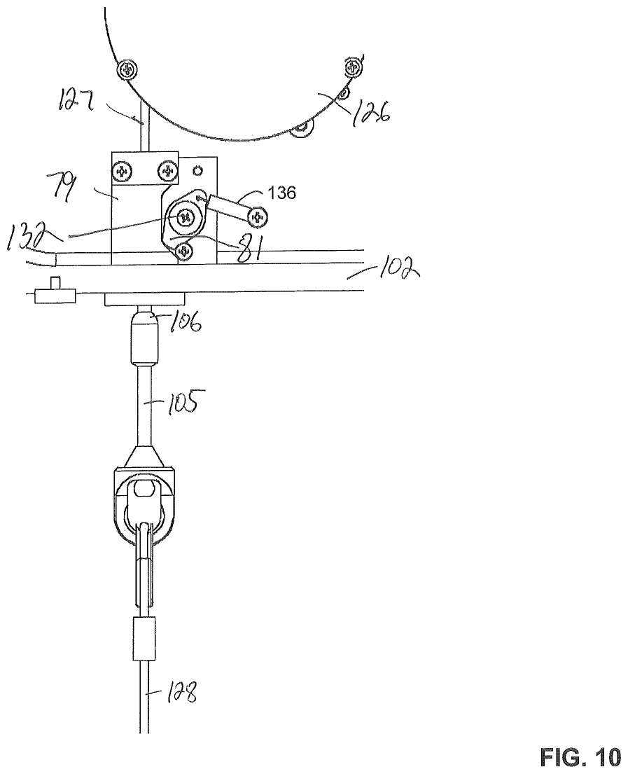

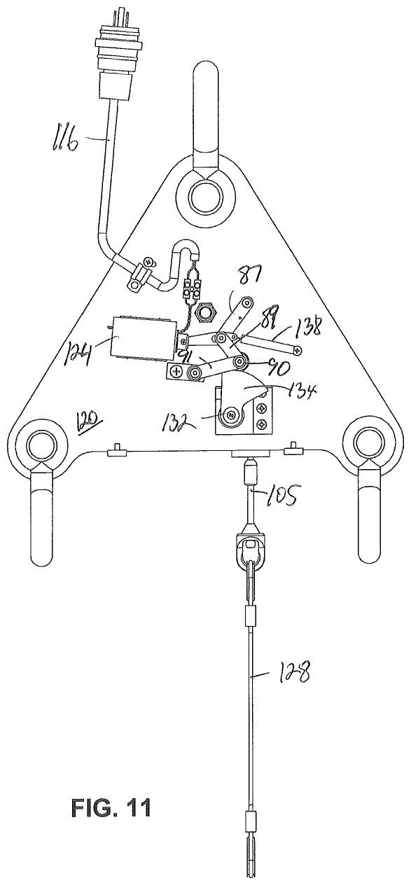

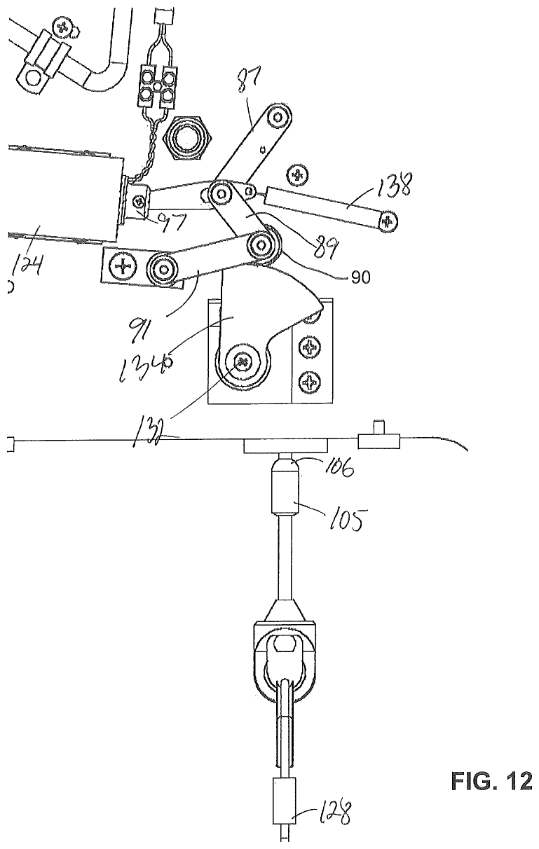

Referring to FIGS. 4-12, a suspension and control head apparatus 100 is shown in detail. Control head 100 comprises a rigid frame member 102 in the shape of a triangle with an upper cargo attachment portion 104 to which is removably connected a shackle 106 for connecting with the cargo hook 20 of the helicopter. Frame member 102 includes lower horizontally spaced apart cable attachment portions 112 and 114 to which are removably connected shackles 117 and 118 respectively. Shackles 117 and 118 enable a convenient way of releasable attaching the support cables 115.

Frame member 102 is planar in that the attachment portions 104, 112 and 114 are in a plane and the frame member defines a first side 120 onto which a solenoid 124 is mounted, and a second side 122 onto which a spring-loaded reel 126 is rotatably mounted. A cable or rope 127 is wound onto the reel 126 when the spring coil within the reel is in a relaxed or nearly relaxed state, and the cable 127 is connected to the control cable 128. A stop member such as stopper 105 is provided near a terminal end of the cable 127. The stopper 105 is received in a guide 79 when the cable 127 is wound onto the reel 126.

A latch 81 engages the stopper 105 and interferes with it being withdrawn from the guide 79 and thereby unwinding of the cable 127 from the reel 126. The latch 81 includes a shaft 132 that communicates from the reel side to the solenoid side 120, on which is provided another latch member 134 connected to the shaft 132. The latch 81 is biased towards engagement with the stopper 105 by spring 136.

On the solenoid side 120, the solenoid 124 receives electrical input via control cable 116 linked to a control module, which could be as simple as an electronic switch, that is manipulated by the operator in the helicopter. When actuated, the solenoid's plunger 97 pulls the levers 87 and 89 towards the solenoid 124 which causes the roller 90 on lever 91 to pull away from the lobe of the latch 134 and thereby to disengage with the latch 134. Latch 134 is directly connected to the latch 81 by shaft 132, thus the release of the latch 134 by the roller 90 allows latch 81 on the reel side 122 to be rotated away from the stopper 105 against the spring 136 on account of downward force on the control line 128 causing the stopper 105 to rotate the latch 81 into the released position, after which the latch 81 is returned toward guide 79 by the spring 136. Thereafter the latch 134 is captured by the roller 90 when it moves back into the resting position by the action of spring 138 when the solenoid 124 is de-actuated, thus locking the latch 81 back in the latched position.

When there is water in the bucket 10, the weight of the water on the dump valve 18 provides tension on the control line 128 that is transmitted to the cable 127. Upon the release of the stopper 105 by the latch 81, this tension unwinds the cable 127 from the reel 126, against the spring tension in the reel, to allow the dump valve to drop through the bottom of the bucket and release the water from the bucket. With the bucket empty, the tension on cable 127 is relieved and the spring tension in reel 126 winds cable 127 back onto the reel, thereby pulling the dump valve 18 back into the bucket body into a closed position to ready the bucket for a further load of water.

Spring 136 pulls latch 81 to its resting position, being rotated into the guide 79. When latch 81 is in its resting position, spring 138 returns the levers and roller 90 to their resting positions in which the roller 90 captures the lobe of the latch 134 thereby locking the latch 81 into the latched position, ready to engage with stopper 105. As the line 127 is wound back onto the reel 126, the stopper 105 sweeps past the latch 81 facilitated by a beveled leading edge 106.

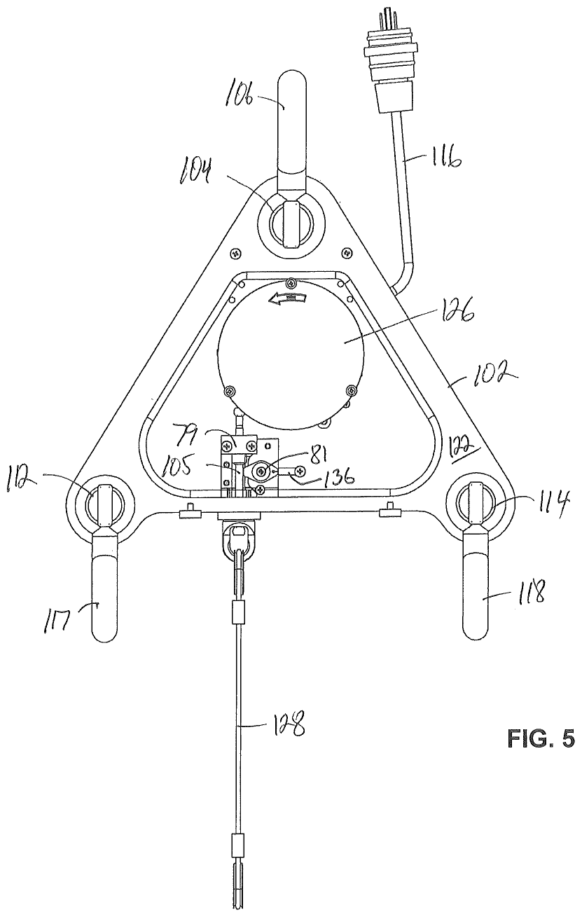

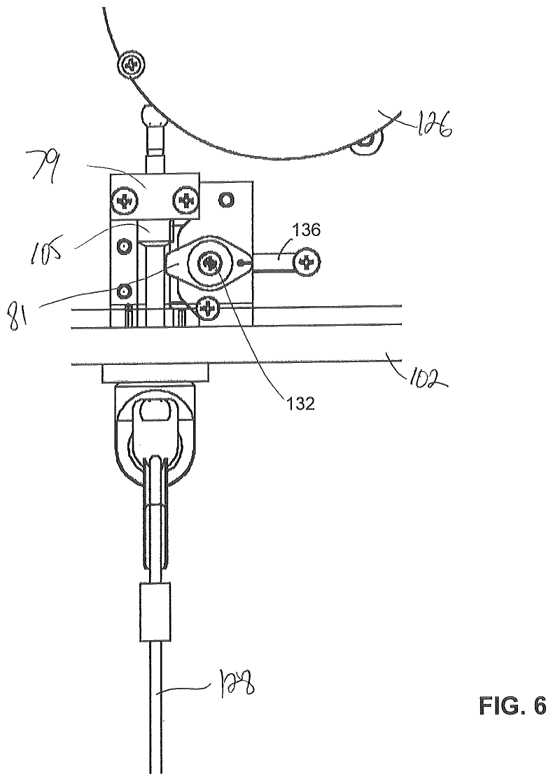

In use, the full bucket 10 is flown to the location of the fire. For dumping the water, the pilot activates the solenoid 124 for a short time. Thereby the plunger 97 pulls the levers 87 and 89 sideways to remove roller 90 from the rotational path of latch 134, against the force of spring 138. As a result, stopper 105 is released and is forced past latch 81 against the force of spring 136 by the downward force on line 128. This allows the dump valve 18 into its extended position under the pressure of the water, as shown in broken lines in FIG. 2. The line 127 unwinds from the reel 126, rotating the reel and winding up the recoil spring within the reel. When the dump valve 18 is fully extended and the water is rushing through the discharge port, the stopper 105 is located below the latch 81 and as soon as the torquing force of the recoil spring exerted on the reel 127 is greater than the downwards pushing force of the remainder of the water, the increasing upwards pull in the line 127 eventually overcomes the force of the remaining water to draw the dump valve back into the bucket. When stopper 105 has passed below latch 81, spring 136 pulls latch 81 back to its resting position. Then when stopper 105 is returning to the fully wound position, stopper 105 causes latch 81 to rotate the other way (clockwise in FIG. 5-6) against the force of spring 136. When stopper 105 is fully seated it releases latch 81, and spring 136 pulls latch back to its resting position.

A second stopper (not shown) may be provided on line 127 to pass through the guide 79, pushing momentarily away the latch 81, while the solenoid is already deactivated such that the pull in the line 127 is stopped by the latch 81 acting on the second stopper to allow the bucket to be emptied completely. The second stopper may be released by another activation of the solenoid that clears the latch 81 from engaging the second stopper and thereby allow the line 127 to be wound up on the reel 127 under the torquing force of the recoil spring. The latch 81 snaps back under the bias of the spring 136 but allows the stopper 105 to pass with its rounded end 106 pushing back the tongue of the latch momentarily. This brings the dump valve back into its withdrawn position and the bucket is ready to be filled again.

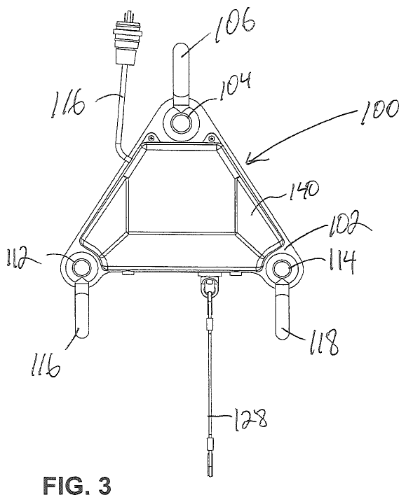

Advantageously, situating the reel mechanism and latch on one side and the solenoid and linkages on the other side in an adjacent location relative to the reel, and connecting the two via a shaft, allows for a compact control mechanism that can be contained within the periphery of the frame member 102, which itself can be compact in height to address one of the shortcomings of the prior art control heads, namely the problem with their height and the risk of interfering with the belly of the helicopter upon landing. A cover 140 on each side of the frame member encloses the mechanisms for protection and aesthetics (as shown in FIG. 3).

The rigid frame member with the horizontally spaced cable attachment portions 112 and 114 allows for the attachment portions to be further spaced apart to alleviate the tendency of the bucket spinning in flight and thereby tangling the suspension and control cables. Hence the bucket support line attachment points may be significantly further apart to provides a significant improvement in preventing the twisting of the lines to address another of the deficiencies in some control heads of the prior art. Preferably the distance between the attachment portions 112 and 114 of the present invention is proportional to the size and weight of the bucket and is sized to create the maximum resistance to twisting for a particular size of bucket.

It is understood that the embodiments described and illustrated herein are merely illustrative of embodiments of the present invention. Other embodiments that would occur to those skilled in the art are contemplated within the scope of the present invention. The invention includes variants not described or illustrated herein in detail. Thus, the embodiments described and illustrated herein should not be considered to limit the invention as construed in accordance with the accompanying claims.

What is claimed is:

1. A suspension and control head apparatus for an aerial firefighting bucket comprising:
a rigid frame member having an upper cargo attachment portion that is removably connectable to a cargo hook of a hover capable aircraft, the frame member including lower spaced apart cable attachment portions that are removably connectable to support cables that support the bucket;
the frame member defining bilateral opposite sides, one side being a solenoid side and the opposite side being a reel side;
a solenoid mounted on the solenoid side, the solenoid being coupled to an electrical source and a switch that energizes and deenergizes the solenoid;
a spring-loaded reel rotatably mounted on the reel side, the reel having wound thereon a cable when the reel is in a relaxed or nearly relaxed state, the cable having a stop member, wherein the solenoid and the reel are adjacent to each other on the opposite sides;
a latch that interferes with the stop member when the latch is in a latched position and the latch being moveable to a released position in which the latch releases the stop member;
a linkage that communicates from the solenoid side to the reel side, the linkage on the solenoid side being connected to the solenoid, the linkage on the reel side being connected to the latch, and the solenoid being operable to release the latch to be moved to the released position when the solenoid is energized; and
wherein with the stop member being released, the cable may be unwound from the reel against the spring bias of the reel with application of a downward force on the cable.

2. The suspension and control head apparatus as claimed in claim 1 wherein the cable is connected to a dump valve of the bucket, and the downward force is provided by the weight of water in the bucket acting upon the dump valve.

3. The suspension and control head apparatus as claimed in any one of claims 1 and 2, wherein the reel is operable to rewind the cable once the downward force is diminished to a lesser magnitude than the force provided by the reel.

4. The suspension and control head apparatus as claimed in any one of claims 1-3, wherein the linkage comprises:
a lobe on the solenoid side;
a shaft connected to the lobe and extending to the reel side and the latch being connected to the shaft; and
the solenoid is operable to release the lobe, which releases the latch to enable the latch to rotate from the latched position to the released position.

5. The suspension and control head apparatus as claimed in claim 4 wherein the linkage further comprises a lever connected to a plunger of the solenoid, the lever having a roller that engages the lobe when the solenoid is deenergized, and wherein energizing the solenoid pulls the lever and the roller to release the lobe and thereby the latch.

6. The suspension and control head apparatus as claimed in any one of claims 1-5, further comprising a guide on the reel side that captures the stop member when the cable is wound onto the reel.

7. The suspension and control head apparatus as claimed in any one of claims 1-6, wherein the frame member is planar such that the cargo attachment portion and the cable attachment portions are in a plane.
